(19) United States
(12) Patent Application Publication
(10) Pub. No.: US 2026/0030076 A1
(43) Pub. Date: Jan. 29, 2026

(54) DYNAMIC LOAD BALANCING BASED ON TRANSACTION CHARACTERISTICS

(71) Applicant: ServiceNow, Inc., Santa Clara, CA (US)

(72) Inventors: Varun Kumar Jayanti, Hyderabad (IN); Kiran Mushnuri, Hyderabad (IN)

(21) Appl. No.: 18/786,196

(22) Filed: Jul. 26, 2024

(51) Int. Cl. G06F 9/50

(52) U.S. Cl. CPC G06F 9/5083; G06F 9/5033; G06F 9/5044

(57) ABSTRACT

In various embodiments, a process for dynamic load balancing based on transaction characteristics includes obtaining, from each of a plurality of network nodes of a network: a respective computing resource status update comprising at least one of: a computing capacity or a resource type; and receiving a transaction request to be executed at the network. The process includes obtaining a transaction type of the transaction request; and determining, based at least on the transaction type and at least a portion of the respective computing resource status updates of the plurality of network nodes, an optimal network node to execute the transaction request. The process includes assigning the transaction request to the optimal network node.

### BACKGROUND OF THE INVENTION

A load balancer is a component in a computing system that distributes tasks to various resources (e.g., computing units/nodes). A load balancer ensures that nodes are not overburdened by directing tasks to nodes with greater capacity, allowing particular (e.g., busy) nodes to recover. However, conventional techniques may result in sub-optimal use of available resources. For example, conventional load balancers typically only consider limited factors related to a node's state when distributing workloads. Because these load balancers only consider limited factors when distributing tasks, the load balancer likely is not picking an optimal node to execute a particular task.

### BRIEF DESCRIPTION OF THE DRAWINGS

Various embodiments of the invention are disclosed in the following detailed description and the accompanying drawings.

FIG. 1 is a block diagram illustrating an embodiment of a system for dynamic load balancing based on transaction characteristics.

FIG. 2 shows an example of transaction processing based on dynamic load balancing based on transaction characteristics.

FIG. 3 is a flow diagram illustrating an embodiment of a process for dynamic load balancing based on transaction characteristics.

FIG. 4 is a functional diagram illustrating a programmed computer system for providing load balancing based on transaction characteristics in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Load balancing refers to distributing tasks to computing nodes (sometimes referred to simply as “nodes,” “computing units,” or “resources”), which may improve overall processing efficiency. Some of the technical problems that load balancing attempts to solve include reducing response times, preventing server overload, avoiding over-utilizing certain nodes while under-utilizing other nodes, and enhancing application availability. Conventional load balancing techniques are typically unable to fully address these technical problems because they are static.

Most existing load balancing techniques are static, meaning they do not take into account the state of the computing nodes or system when assigning tasks. Examples of static load balancing algorithms include round robin assignment where tasks are assigned in a cyclic order without regard for the priority of the tasks or the current load or state of a node, weighted load balancing where each computing node is assigned a weight proportional to its computing capacity and more tasks are assigned to nodes with higher weights relative to nodes with lower weights, and IP (internet protocol)-hashed assignments where the source and/or destination IP address of a task is used to generate a unique hash key that is used to allocate the task to a particular computing node. Dynamic load balancing techniques are being developed. For example, tasks may be dynamically moved from an over-utilized node to an under-utilized node. However, conventional dynamic load balancing techniques are unaware of the characteristics of the tasks.

The disclosed techniques offer a technical solution to the technical problem of load balancing by performing dynamic load balancing based on transaction characteristics. The characteristics of a task/transaction are taken into consideration when determining how to distribute the transaction to a network node for execution. In various embodiments, characteristics of a transaction and/or node conditions are determined. The transaction characteristics and/or node conditions may be used to determine how to distribute traffic to the nodes. For example, a resource is marked with a certain type of transaction, and rule(s) are configured at the load balancer to route traffic to the node that is best able to handle that type of transaction at that moment.

Taking into account the nature of the tasks being distributed among computing nodes improves load balancing by better meeting load balancing objectives including but not limited to: reducing response times, preventing server overload, optimization resource (e.g., node) utilization, enhancing application availability, improving scalability (e.g., enabling unused nodes to be shut off), and security. Consequently, the overall processing efficiency of a system in which the disclosed load balancing techniques are deployed is improved and operational costs are reduced.

Considering the characteristics/type of a transaction in addition to the state of a node may improve load balancing compared with techniques that do not do so. For example, consider a situation in which a node is 80% CPU-occupied and a CPU load threshold is 80%. Conventional techniques that solely consider node state would not assign any further tasks to this node because the node is considered to be fully loaded based on meeting the CPU load threshold. Despite being fully loaded with respect to CPU processing ability, the node may still be capable of processing CPU-light transactions such as database transactions or memory-intensive transactions. Therefore, a more efficient use of the node would be to continue to assign non-CPU heavy tasks to the node. However, conventional techniques are not aware of transaction type (e.g., how much CPU computing power, database connections, or memory usage is expected for a particular transaction).

The disclosed load balancing techniques may be applied in a variety of settings. For example, the techniques may be applied for Web applications or platform as a service (PaaS) to improve the functioning of the Web applications or PaaS by using fewer computing resources that maintain or improve latency and performance. Unlike conventional load balancers, which are typically unaware of (or not fully aware of) the nature of a transaction (e.g., a transaction type or characteristics of the transaction), the disclosed techniques include determining a state of a computing node and the expected computational needs of an application to assign a workload/transaction to a computing node. The assignment is determined in a way that optimizes the functioning of the system by assigning a transaction to a first available computing node capable of executing the transaction so that unused computing nodes may be turned off. Because conventional load balancers typically do not take into consideration that transaction type, the transaction may be assigned to a sub-optimal computing node for execution. The technical problem of assigning workloads to sub-optimal computing nodes is solved by the disclosed techniques, which determine an optimal computing node to assign a workload based on characteristics of the workload as well as the potential computing nodes to which the workload may be assigned.

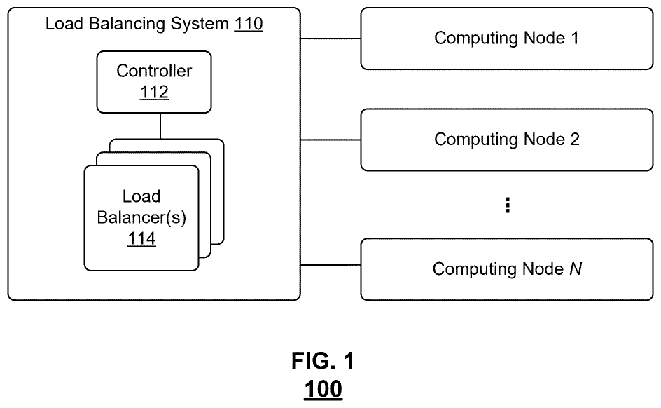

FIG. 1 is a block diagram illustrating an embodiment of a system for dynamic load balancing based on transaction characteristics. The system includes a load balancing system 110 and one or more computing nodes (Computing Node 1 to Computing Node N).

The system 100 includes a load balancing system 110 that assigns transactions (sometimes called “tasks” or “workloads”) to a computing node to complete the transaction. The system may include any number of computing nodes. Here, there are N nodes, labeled “Computing Node 1” through “Computing Node N.” The system 100 may be implemented in a variety of ways, such as a Kubernetes cluster that enables containerized applications to be deployed and scaled. Each of the controller 112, load balancers 114, and computing nodes 1 to N may be implemented by one or more software and/or hardware devices.

As further described herein, the functioning of the system 100 may be improved by optimizing the use of the computing nodes based on the disclosed load balancing techniques. For example, transactions may be dynamically and efficiently assigned to computing nodes so that un-used computing nodes are turned off or otherwise disabled. Fewer active computing nodes corresponds to increased efficiency and reduced cost because un-used nodes are not kept active.

An example of transaction processing will now be described in the context of system 100 as shown in the following figure.

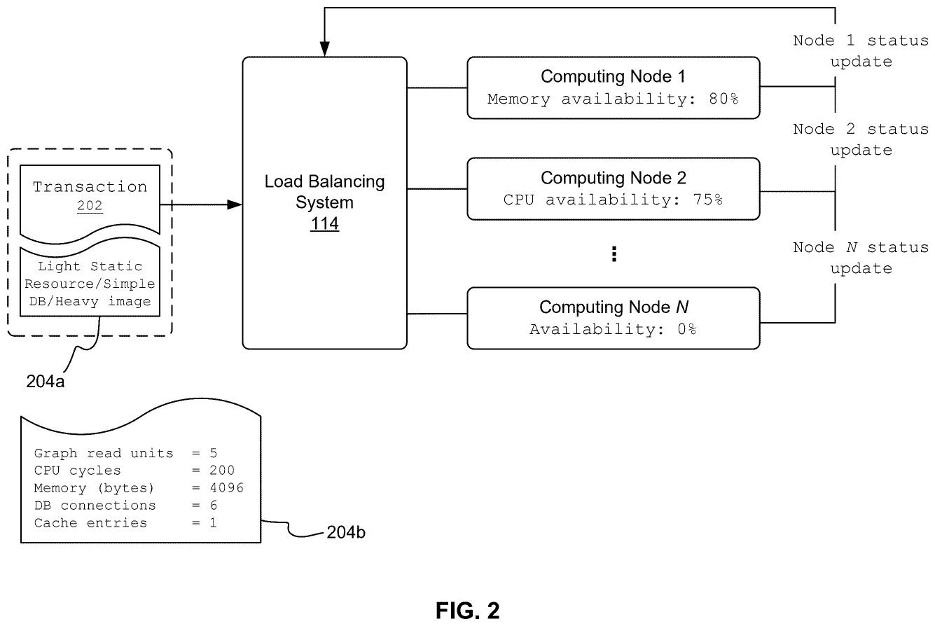

FIG. 2 shows an example of transaction processing based on dynamic load balancing based on transaction characteristics. Each of the components are like their counterparts in FIG. 1 unless otherwise described.

Load balancing system 114 is configured to receive a transaction 202 and distribute the transaction to a computing node (here, Computing Node 1, 2, or N) for execution. Transaction 202 is a light static resource request. Its type/characteristics are shown in 204a, which notes that transaction 202 involves a light static resource, simple database, and heavy image. This type of transaction could be served by any node with sufficient resource. Because the transaction involves a large/heavy image, a computing node with sufficient memory availability would best serve this transaction. Therefore, the transaction may be assigned to Computing Node 1.

The transaction characteristics may be transmitted as part of the transaction, e.g., as metadata as further described herein. The transaction characteristics may be listed in a variety of ways including a qualitative manner or quantitative manner. In this example, 204b shows another way that the transaction characteristics may be encoded. In 204b, expected resource consumption is listed, e.g., five graph read units (sometimes referred to as graphical processing unit/GPU read units), 200 CPU cycles, 4096 bytes, six database connection, and one cache entry. A graph read unit refers to resources expended on the cloud to retrieve data associated with a particular transaction from a graph database. For example, graph read units needed for a transaction may be determined when testing a graph database query by observing how many read units are consumed to service the query. The examples shown in 204a and 204b are merely exemplary and not intended to be limiting. For example, there may be fewer or more parameters/characteristics based on the type of system (e.g., machine learning, artificial intelligence, Web applications, scripts, etc.). Other examples of characteristics include cache memory, generative AI invocations, neural network computations, ML/AI invocations, subsidiary system resource utilization such as read replicas, among others.

The transaction type may include one or more parameters, but not all transactions have the same parameters in various embodiments. For example, a static resource request typically does not have graph read cycles or CPU cycles. As another example, a transaction type may consume various resources, but the transaction type need not list all resource type consumption but instead includes the minimal criterion/criteria (e.g., mission critical criterion/criteria) to process the transaction.

The following are further, non-limiting examples of transaction types:
Transaction A querying details of a user is a basic database call such as a database CRUD (create, read, update, and delete) call. This type of transaction is complex in terms of database connections, but it is not memory-intensive or CPU intensive.
Transaction B that querying data of all employees of a level within a particular range (e.g., senior engineers to staff engineers) who have joined after a particular date is considered a database-intensive transaction. This type of transaction is complex in terms of database connections, but it is not memory-intensive or CPU intensive.
Both transaction A and transaction B may be considered to be the same type of transaction, e.g., database-intensive. In various embodiments, the transaction type may be quantified. For example, although transactions A and B are of the same type they may be assigned a number of units reflecting the level of intensity with respect to database resources needed.
Integration traffic is a query that is generated by other nodes and not by a user. Integration traffic is typically handled by worker nodes. There is some data within a particular instance, e.g., within a particular Now Platform node, which is periodically synced to another system because the other system also needs certain data such as user data. Integration traffic is typically background processing.

In contrast with conventional load balancing techniques, which typically only take into consideration node status (e.g., Node 1 status update, Node 2 status update, etc.), the disclosed techniques consider the characteristics of a transaction (e.g., 204a or 204b) to assign a transaction to a computing node for completion.

In this example, although each computing node is shown with only one category of availability, e.g., memory availability 80% for Node 1, CPU availability 75% for Node 2, this may be a simplification. The category with the best availability is shown to more clearly illustrate the example. Suppose that Node 1 has memory availability 80% and CPU availability 75%. Node 1 would be assigned any transaction that can be sufficiently served by Node 1, given the node's available resources. As another example, suppose that Node 1 has DB availability 5%. Then, a transaction requiring more DB availability would not be assigned to Node 1. Unlike conventional techniques, which typically consider a node's availability as a binary condition, e.g., available or not, the disclosed techniques are more nuanced and will assign a transaction to a node so long as a particular category of resources is sufficient to serve the transaction, because the transaction's characteristics (e.g., expected consumption of a particular category of resources) is known.

A process for dynamic load balancing will now be described in the context of the following figure, which is a generalization of the specific example described in FIG. 2.

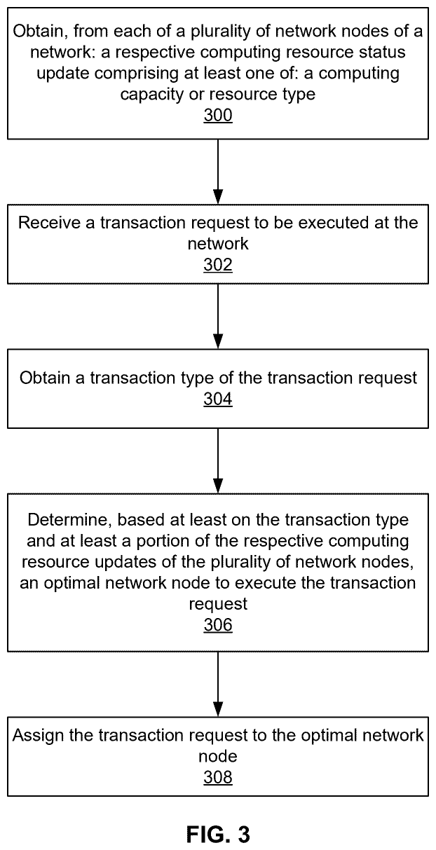

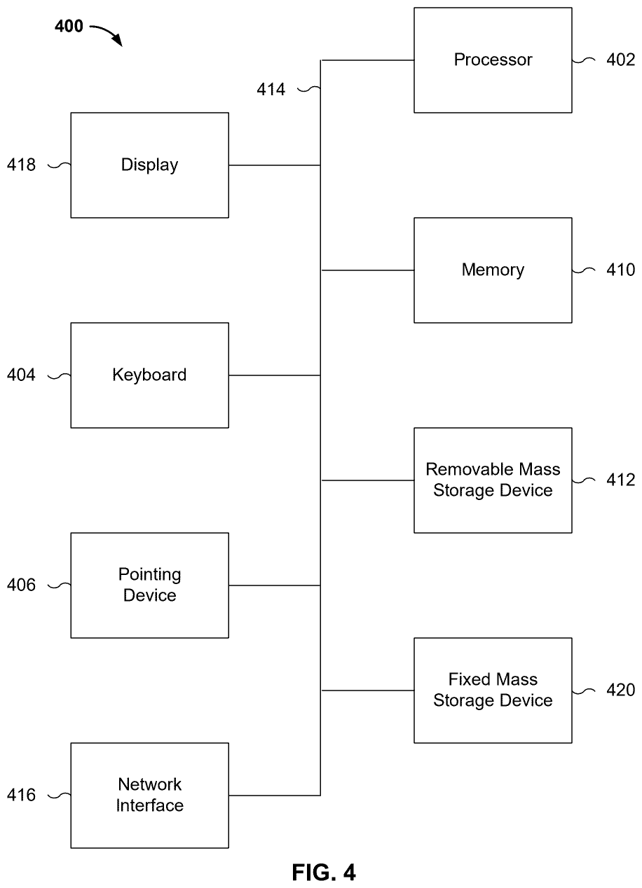

FIG. 3 is a flow diagram illustrating an embodiment of a process for dynamic load balancing based on transaction characteristics. This process may be implemented on or by the load balancing system 110 shown in FIG. 1 or the processor 4 of FIG. 4.

In the example shown, the process begins by obtaining, from each of a plurality of network nodes of a network: a respective computing resource status update comprising at least one of: a computing capacity or a resource type (300). Referring briefly to FIG. 2, an example of a computing resource status update is Node 1 status update, Node 2 status update, and Node N status update.

A technical benefit of obtaining a computing resource status update is that the computing resource (e.g., computing capacity and/or resource type) may be taken into consideration when performing load balancing.

In various embodiments, the respective computing resource status update includes a node signal indicating a characteristic and/or a state of a respective network node of the plurality of network nodes. Examples of computing resource status updates include node conditions (which may be reported in real-time or near real-time, e.g., as resource status updates) such as, without limitation:
Node type, e.g., front-end (UI) vs. back-end/background (worker)
Semaphores/DB connections/threads available for use on a particular node
Memory/CPU statistics of the particular node at a particular time

In various embodiments, the respective computing resource status update is associated with executing at least one transaction request. In various embodiments, the respective computing resource status update is real-time or near real-time. For example, they may be reported every few seconds or more frequently.

The process receives a transaction request to be executed at the network (302). In various embodiments, a transaction request is a request for the network to perform a task and may have an associated workload. Referring briefly to FIG. 2, a transaction request is 202.

The process obtains a transaction type of the transaction request (304). The transaction type of the transaction indicates expected resources consumed to complete the transaction. The expected resources may be broken down into one or more categories or parameters. Thus, the transaction type is also sometimes referred to as transaction characteristics. Referring briefly to FIG. 2, an example of a transaction type is 204a and another example of a transaction type is 204b.

A transaction type may be indicated by one or more rules. Examples of transaction types include, without limitation, memory-intensive, CPU-intensive, database-intensive. The transaction type may be qualitative (as in the previous example) and/or may be quantitative.

A technical benefit of obtaining a transaction type of the transaction request is that characteristics of the transaction (qualitative and/or quantitative, as further described herein) may be taken into consideration when performing load balancing. Experiments have shown improvements to the functioning of an entire load balancing and computing system because transactions are assigned to network nodes that have the specific category of computing resource capable of processing transactions, even if other categories of the computing resource may already be full.

Examples of transaction characteristics include:
Resources expected to be consumed such as, without limitation:
   Graphical processing unit (GPU) read units
   CPU cycles
   Memory (e.g., in bytes)
   Database connections
   Cache entries
   Cloud cycles
Based on resources consumed, a transaction may be determined to be of a specific type such as:
   Heavy static (indicates the transaction will be a memory intensive operation on a server
   Complex database query
Any characteristic or transaction type that may be indicated by a developer, e.g., via metadata
Any characteristic or transaction type that may be observed, e.g., via machine learning.
Any characteristic or transaction type that may be determined by mapping a Uniform Resource Locator (URL) with resource utilization

In other words, the computing capacity may include at least one of: central processing unit (CPU) cycles or graphical processing unit (GPU) read units. The resource type may include database connections and/or memory.

The disclosed techniques include determining the characteristics of a transaction, and assigning the transaction to a node that is able to handle transactions having those characteristics. The transaction characteristics/type may be determined based on metadata encoding the information provided by a developer, from observing the transaction or similar transactions over time, among others, as further described herein. For example, a machine learning model may be trained to receive a transaction as input and output the type or characteristics of the transaction.

In various embodiments, the transaction type of the transaction request includes an expected computing resource consumption to execute the transaction request. The transaction type of the transaction request may include an expected level of consumption of a category of computing resource to execute the transaction request.

The transaction type of the transaction request includes at least one of the following parameters associated with executing the transaction request: graphical processing unit (GPU) read units, central processing unit (CPU) cycles, memory consumption, number of database connections, or number of cache entries.

A developer or a computer program can indicate the transaction type. For example, the metadata of the transaction type may include expected parameters or characteristics of the transaction. In other words, the transaction type of the transaction request is indicated by metadata associated with the transaction request. The transaction type of the transaction request is encoded by a developer of a computer program associated with the transaction request.

For example, a developer may be presented with a list of possible transaction types and indicate the appropriate type for a particular transaction. As another example, a developer may indicate a quantity of resources used for a particular transaction. For example, a transaction may be indicated to use n (e.g., n=eight) database connections, j units (e.g., j=10 MB) of memory. For example, there may be several fields each corresponding to a particular resource that the developer fills out to indicate characteristics of the transaction. The developer may determine the appropriate values based on experience, observation/testing, among others.

In various embodiments, the transaction type of the transaction request is obtained from a machine learning model, wherein the machine learning model is trained based at least on a resource utilization of a network node to execute the transaction request and/or another transaction request within a threshold level of similarity to the transaction request.

For example, training data for the machine learning model may be formed as follows. Transactions within a pre-defined period of time (e.g., a few months) may be observed to determine the maximum quantity of a particular type of resource (e.g., database, CPU, memory) needed to perform the transaction.

A request received by a load balancer typically has an associated URL. The URL has an associated IP address, which indicates a destination and requested content, if applicable. Resource utilization is determined based on node signals (e.g., computing resource status updates which may include computing capacity and/or resource type). When a transaction is assigned to a node, the respective utilization is reflected in node signals obtained from one or more network nodes. The observation of when a transaction is completed may be based on log data. The log data or other indication of when a transaction is completed may be included in the node signals. The system maps the URL with the resource utilization. The system stores the mapping, and dynamically routes based on this information.

For example, consider a transaction that is a document call for a static resource such as an HTTP call to a server (e.g., GET to access a page). The transaction is attempting to obtain a page as a resource. The transaction type would be determined to be “serve static resource.”

The process determines, based at least on the transaction type and at least a portion of the respective computing resource status updates of the plurality of network nodes, an optimal network node to execute the transaction request (306). A network node may be considered to be an optimal network node when using the particular network node rather than another network node would better meet load balancing goals. Referring briefly to FIG. 2, an optimal network node for the example transaction 202 is Computing Node 1.

A technical benefit of selecting an optimal network node rather than any other network node to execute the transaction request is that the functioning of a system that uses the disclosed load balancing techniques will be improved. For example, a node that does not have many available CPU cycles may nevertheless be able to execute a transaction that requires many database connections but not many CPU cycles. In other words, a node is used to its full potential, allowing underutilized nodes to be not used at all.

In various embodiments, determining the optimal network node is based at least on a dynamic rule. A dynamic rule determines which of the plurality of network nodes to assign to based on the respective computing resource status updates. For example, the dynamic rule assigns to a network node of the plurality of network nodes having the at least one of: a computing capacity or a resource type sufficient to execute the transaction request.

Referring to 204b of FIG. 2, any network node that can meet the resource needs as indicated by each category can be assigned the transaction request. In contrast with conventional techniques which might not assign the transaction to a node that is considered “overloaded”, which is wasteful because network node is in fact able to service the transaction request, the disclosed techniques may cause the transaction request to be assigned to a network node that is fully loaded in one category but has availability in another category that matches the needs of a transaction.

In various embodiments, determining the optimal network node is based at least on minimizing a number of active network nodes in the plurality of network nodes. For example, if multiple network nodes are able to handle a transaction request, the transaction request may be assigned in a first available network node or any other appropriate manner to meet objectives. The optimal network node is a first available network node of the plurality of network nodes capable of executing the transaction request. For example, the first available network node may be used if an objective is to keep the idle nodes idle for as long as possible so that the cluster will automatically turn them off if there is no traffic. If traffic is consistently assigned to a particular node and not to another node, then the cluster of nodes understands that the other node is redundant ad the node will be automatically turned off. This may be considered resource optimization because fewer nodes are deployed on the cloud, which decreases costs based on a pricing scheme that charges per active node.

Safety/security precautions may be implemented to define threshold levels of operation that constitute operating a network node to its full potential. For example, operating at 90% of a network node's capacity means 10% capacity/buffer is reserved to avoid issues such as a memory or a heap burnout.

Suppose a goal of resource optimization is to always have three active network nodes. Then assignment of transaction to network node may be performed in a round-robin fashion among the three network nodes if all three are able to meet transaction characteristics.

Example rules include:
Heavy static transactions are routed to a node that has available memory above a threshold (e.g., 1 GB)
Complex database query transactions are routed to a node that has CPU load below a threshold (e.g., 30%) and available database connections above a threshold (e.g., 10)
Dynamically switching between static rules or adaptations of static rules such as round robin, weighted load balancing, IP-hashed
Assign a transaction to a first available node that has resources sufficient to accommodate a transaction, given the transaction's characteristics so that the minimum number of nodes are used. Unused nodes may be turned off, so that fewer resources are used compared with leaving the nodes turned on.

The process assigns the transaction request to the optimal network node (308). In various embodiments, assigning the transaction request to the optimal network node includes forwarding the transaction to the network node for completion.

The disclosed techniques may be applied to a variety of architectures, including those with nodes that are aware of the presence of other nodes or standalone nodes (where a particular node is unaware of other nodes). Nodes that are aware of other nodes may store information such as user credentials to serve responses to a particular user more efficiently without needing to re-authenticate.

A Web application refers to software that is accessed via a Web browser. The Web application may be accessible by a variety of hardware devices such as computers or smartphones that have Web browsers.

A platform as a service (PaaS) or application platform as a service (aPaaS) refers to PaaS environment supporting the creation, hosting, and deployment of applications that abstracts the underlying infrastructure so that applications may be managed without needing to be familiar with the complexities of infrastructure such as servers or databases.

In the context of load balancing for PaaS, one adjustment may be made. In a PaaS where nodes are unaware of each other, if a specific transaction request is linked to a specific user, then the transaction request will be assigned to an earlier node that had previously handled a transaction request for the specific user so long as the earlier node has the resources to complete the transaction. It is more efficient to assign a transaction associated with a specific user to a node that had earlier executed a transaction for that user because it may already have relevant user information stored and therefore expends fewer resources to complete the transaction compared with a node that has not previously executed a transaction for the particular user.

FIG. 4 is a functional diagram illustrating a programmed computer system for providing load balancing based on transaction characteristics in accordance with some embodiments. As will be apparent, other computer system architectures and configurations can be used to provide load balancing based on transaction characteristics. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general-purpose digital processor that controls the operation of the computer system 400. Using instructions retrieved from memory 410, the processor 402 controls the reception and manipulation of input data, and the output and display of data on output devices (e.g., display 418). In some embodiments, processor 402 includes and/or is used to provide a load balancing system described herein with respect to FIG. 1 and/or executes/performs the process described herein with respect to FIG. 3.

Processor 402 is coupled bi-directionally with memory 410, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown).

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storage 412, 420 generally store additional programming instructions, data, and the like that typically are not in active use by the processor 402. It will be appreciated that the information retained within mass storage 412 and 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining, from each of a plurality of network nodes of a network: a respective computing resource status update comprising at least one of: a computing capacity or a resource type;
receiving a transaction request to be executed at the network;
obtaining a transaction type of the transaction request;
determining, based at least on the transaction type and at least a portion of the respective computing resource status updates of the plurality of network nodes, an optimal network node to execute the transaction request; and
assigning the transaction request to the optimal network node.

2. The method of claim 1, wherein the respective computing resource status update includes a node signal including at least one of: a characteristic or a state of a respective network node of the plurality of network nodes.

3. The method of claim 1, wherein the respective computing resource status update is associated with executing at least one transaction request.

4. The method of claim 1, wherein the computing capacity includes at least one of: central processing unit (CPU) cycles or graphical processing unit (GPU) read units.

5. The method of claim 1, wherein the resource type includes at least one of: database connections or memory.

6. The method of claim 1, wherein the transaction type of the transaction request includes an expected computing resource consumption to execute the transaction request.

7. The method of claim 1, wherein the transaction type of the transaction request includes an expected level of consumption of a category of computing resource to execute the transaction request.

8. The method of claim 1, wherein the transaction type of the transaction request includes at least one of the following parameters associated with executing the transaction request: graphical processing unit (GPU) read units, central processing unit (CPU) cycles, memory consumption, number of database connections, or number of cache entries.

9. The method of claim 1, wherein the transaction type of the transaction request is indicated by metadata associated with the transaction request.

10. The method of claim 9, wherein the transaction type of the transaction request is encoded by a developer of a computer program associated with the transaction request.

11. The method of claim 1, wherein the transaction type of the transaction request is obtained from a machine learning model, wherein the machine learning model is trained based at least on a resource utilization of a network node to execute at least one of: the transaction request or another transaction request within a threshold level of similarity to the transaction request.

12. The method of claim 1, wherein determining the optimal network node is based at least on a dynamic rule.

13. The method of claim 1, wherein determining the optimal network node is based at least on a dynamic rule that assigns to a network node of the plurality of network nodes having the at least one of: a computing capacity or a resource type sufficient to execute the transaction request.

14. The method of claim 1, wherein determining the optimal network node is based at least on minimizing a number of active network nodes in the plurality of network nodes.

15. The method of claim 14, wherein the optimal network node is a first available network node of the plurality of network nodes capable of executing the transaction request.

16. The method of claim 1, wherein the network is associated with a platform as a service (PaaS) and the optimal network node is a first available network node of the plurality of network nodes capable of executing the transaction request that has previously executed a transaction request associated with a same user as a user associated with the transaction request.

17. A system, comprising:
a processor configured to:
obtain, from each of a plurality of network nodes of a network: a respective computing resource status update comprising at least one of: a computing capacity or a resource type;
receive a transaction request to be executed at the network;
obtain a transaction type of the transaction request;
determine, based at least on the transaction type and at least a portion of the respective computing resource status updates of the plurality of network nodes, an optimal network node to execute the transaction request; and
assign the transaction request to the optimal network node; and
a memory coupled to the processor and configured to provide the processor with instructions.

18. The system of claim 16, wherein the transaction type of the transaction request includes an expected level of consumption of a category of computing resource to execute the transaction request.

19. The system of claim 16, wherein the transaction type of the transaction request is at least one of: indicated by metadata associated with the transaction request or obtained from a machine learning model, wherein the machine learning model is trained based at least on a resource utilization of a network node to execute at least one of: the transaction request or another transaction request within a threshold level of similarity to the transaction request.

20. A computer program product embodied in a non-transitory computer readable medium and comprising computer instructions for:
obtaining, from each of a plurality of network nodes of a network: a respective computing resource status update comprising at least one of: a computing capacity or a resource type;
receiving a transaction request to be executed at the network;
obtaining a transaction type of the transaction request;
determining, based at least on the transaction type and at least a portion of the respective computing resource status updates of the plurality of network nodes, an optimal network node to execute the transaction request; and
assigning the transaction request to the optimal network node.
